(19) United States
(12) Patent Application Publication
(10) Pub. No.: US 2023/0114952 A1
(43) Pub. Date: Apr. 13, 2023

(54) INKJET INK

(71) Applicant: KYOCERA Document Solutions Inc., Osaka (JP)

(72) Inventor: Erika TANAKA, Osaka-shi (JP)

(73) Assignee: KYOCERA Document Solutions Inc., Osaka (JP)

(21) Appl. No.: 17/938,655

(22) Filed: Oct. 6, 2022

(30) Foreign Application Priority Data
Oct. 7, 2021 (JP) 2021-165517

(51) Int. Cl. C09D 11/322; C09D 11/36

(52) U.S. Cl. CPC C09D 11/322; C09D 11/36

(57) ABSTRACT

An inkjet ink contains a pigment, a polysaccharide, a water-soluble organic solvent, and self-emulsifying polyolefin resin particles. The polysaccharide has a percentage content of at least 0.01% by mass and no greater than 0.20% by mass. The water-soluble organic solvent contains a specific glycol ether compound. The specific glycol ether compound has a percentage content of at least 3.0% by mass and no greater than 24.0% by mass. A ratio (M_{Y}/M_{X}) of a mass M_{Y} of the pigment to a mass M_{X} of the self-emulsifying polyolefin resin particles is at least 0.24 and no greater than 3.10.

### INCORPORATION BY REFERENCE

The present application claims priority under 35 U.S.C. § 119 to Japanese Patent Application No. 2021-165517, filed on Oct. 7, 2021. The contents of this application are incorporated herein by reference in their entirety.

### BACKGROUND

The present disclosure relates to an inkjet ink.

A water-based inkjet ink containing a pigment and an aqueous medium is used in inkjet recording apparatuses in some cases. There is a demand that the inkjet ink should have excellent ejection stability. An inkjet recording apparatus forms an image on a non-permeable recording medium such as an oriented polypropylene (OPP) film in some cases. When an image is formed on such a non-permeable recording medium using the inkjet recording apparatus, the formed image tends to have an image defect (e.g., occurrence of blotting or ink repelling). Furthermore, the image formed on the non-permeable recording medium using the inkjet recording apparatus tends to have low adhesion. As such, the image may peel off from the recording medium upon being rubbed by a member other than the recording medium. Therefore, there is a demand that the inkjet ink in such application should form an image excellent in adhesion while occurrence of blotting and ink repelling be inhibited even in image formation on a non-permeably recording medium.

To address such demands, an inkjet ink is proposed that contains for example natural polysaccharides, a colorant, and a solvent. The above inkjet ink is thought to inhibit generation of blots in image formation on a non-permeable recording medium.

### SUMMARY

An inkjet ink according to an aspect of the present disclosure contains a pigment, a polysaccharide, a water-soluble organic solvent, and self-emulsifying polyolefin resin particles. The polysaccharide has a percentage content of at least 0.01% by mass and no greater than 0.20% by mass. The water-soluble organic solvent contains a specific glycol ether compound. The specific glycol ether compound includes propylene glycol monomethyl ether, propylene glycol monopropyl either, dipropylene glycol monomethyl ether, dipropylene glycol monopropyl ether, or triethylene glycol monobutyl ether. The specific glycol ether compound has a percentage content of at least 3.0% by mass and no greater than 24.0% by mass. A ratio (M_{Y}/M_{X}) of a mass M_{Y} of the pigment to a mass M_{X} of the self-emulsifying polyolefin resin particles is at least 0.24 and no greater than 3.10.

### DETAILED DESCRIPTION

The following describes an embodiment of the present disclosure. In the following, measurement values for volume median diameter (D₅₀) are values as measured using a dynamic light scattering type particle size distribution analyzer (“ZETASIZER NANO ZS”, product of Malvern Instruments Ltd.) unless otherwise stated. In the present specification, the term “(meth)acryl” may be used as a generic term for both acryl and methacryl.

<Ink>

The following describes an inkjet ink (also referred to below simply as ink) according to an embodiment of the present disclosure. The ink of the present disclosure contains a pigment, a polysaccharide, a water-soluble organic solvent, and self-emulsifying polyolefin resin particles. The polysaccharide has a percentage content of at least 0.01% by mass and no greater than 0.20% by mass. The water-soluble organic solvent contains a specific glycol ether compound. The specific glycol ether compound includes propylene glycol monomethyl ether, propylene glycol monopropyl either, dipropylene glycol monomethyl ether, dipropylene glycol monopropyl ether, or triethylene glycol monobutyl ether. The specific glycol ether compound has a percentage content of at least 3.0% by mass and no greater than 24.0% by mass. A ratio (M_{Y}/M_{X}) of a mass M_{Y} of the pigment to a mass M_{X} of the self-emulsifying polyolefin resin particles is at least 0.24 and no greater than 3.10. Preferably, the ink of the present disclosure further contains at least one of a pigment coating resin, water, a specific glycol compound, and a surfactant.

No particular limitations are placed on use of the ink of the present disclosure, and the ink can be used for image formation on permeable recording mediums and non-permeable recording mediums, for example. The ink of the present disclosure is suitably used for image formation on the non-permeable recording mediums. The permeable recording mediums are excellent in ink penetration. Examples of the permeable recording mediums include printing paper and mediums (e.g., cloth) of which a raw material is fiber. Examples of the printing paper include plain paper, copy paper, recycled paper, thin paper, thick paper, and glossy paper.

The non-permeable recording mediums are inferior to the permeable recording mediums in ink penetration. The non-permeable recording mediums absorb an aqueous medium in an absorption amount of no greater than 1.0 g/m², for example. Examples of the non-permeable recording mediums include a resin-made recording medium, a metal-made recording medium, and a glass-made recording medium. Examples of the resin-made recording medium include a resin sheet and a resin film. A resin contained in the resin-made recording medium is preferably a thermoplastic resin. Specific examples of the resin include polyethylene, polypropylene, polyvinyl chloride, and polyethylene terephthalate (PET). Examples of the resin-made recording medium include an OPP film. In image formation on a resin-made recording medium with the ink of the present disclosure, the surface (printing surface) of the recording medium may be subjected to corona treatment.

As a result of having the above features, the ink of the present disclosure can be excellent in ejection stability and can form an image excellent in adhesion while generation of blots and occurrence of ink repelling are inhibited in image formation on a non-permeable recording medium. The reasons therefor can be presumed as follows. The ink of the present disclosure contains a certain amount or more of self-emulsifying polyolefin resin particles. The self-emulsifying polyolefin resin particles function as binder resin particles to ensure adhesion of an image formed with the ink of the present disclosure to a recording medium. Among various types of binder resin particles, the polyolefin resin particles have excellent compatibility with the non-permeable recording mediums (particularly, an OPP film). Furthermore, the self-emulsifying resin particles are dispersible even in an ink not containing a large amount of a surfactant or an emulsifier having a tendency to decrease adhesion to a recording medium. Therefore, as a result of containing self-emulsifying polyolefin resin particles as binder resin particles, the ink of the present disclosure can form an image excellent in adhesion to a non-permeable recording medium.

Moreover, the ink of the present disclosure contains a certain amount or more of a polysaccharide that is one type of a thickener. The polysaccharide imparts appropriate viscosity to the ink of the present disclosure. The ink of the present disclosure can accordingly inhibit generation of blots in image formation on a non-permeable recording medium. By contrast, a typical ink with binder resin particles and a thickener excessively added thereto tends to have decreased ejection stability. In view of the foregoing, the ratio (M_{Y}/M_{X}) of the mass M_{Y} of the pigment to the mass M_{X} of the self-emulsifying polyolefin resin particles is set to at least 0.25 and the percentage content of the polysaccharide is set to no greater than 0.20% by mass in the ink of the present disclosure. That is, the ink of the present disclosure does not contain excessive amounts of the self-emulsifying polyolefin resin particles and the polysaccharide. Furthermore, among thickeners, the polysaccharide has the least impact on ejection stability of an ink. Therefore, the ink of the present disclosure is excellent in ejection stability because impairment of ejection stability caused by adding binder resin particles (self-emulsifying polyolefin resin particles) and a thickener (polysaccharide) is inhibited.

In addition, the ink of the present disclosure contains the specific glycol ether compound. The specific glycol ether compound functions as a lubricant to optimize wettability of the ink of the present disclosure to a non-permeable recording medium. Among lubricants, the specific glycol ether compound is excellent in compatibility with the other components contained in the ink of the present disclosure and can cause the ink to effectively exhibit wettability to a non-permeable recording medium. Therefore, as a result of containing the specific glycol ether compound as a lubricant, the ink of the present disclosure can inhibit occurrence of ink repelling in image formation on a non-permeable recording medium.

The following describes the ink of the present disclosure further in detail. Note that as to each component described below, one type of the component may be used independently or two or more types of the component may be used in combination.

[Pigment]

In the ink of the present disclosure, the pigment constitutes pigment particles together with a pigment coating resin, for example. The pigment particles are each constituted by a core containing the pigment and the pigment coating resin covering the core. The pigment coating resin is present in a state of being dispersed in a solvent, for example. In terms of optimization of color density, hue, or stability of the ink of the present disclosure, the pigment particles have a volume median diameter of preferably at least 30 nm and no greater than 200 nm, and more preferably at least 70 nm and no greater than 130 nm.

Examples of the pigment include yellow pigments, orange pigments, red pigments, blue pigments, violet pigments, and black pigments. Examples of the yellow pigments include C.I. Pigment Yellow (74, 93, 95, 109, 110, 120, 128, 138, 139, 151, 154, 155, 173, 180, 185, or 193). Examples of the orange pigments include C.I. Pigment Orange (34, 36, 43, 61, 63, or 71). Examples of the red pigments include C.I. Pigment Red (122 or 202). Examples of the blue pigments include C.I. Pigment Blue (15, specifically, 15:3). Examples of the violet pigments include C.I. Pigment Violet (19, 23, or 33). Examples of the black pigments include C.I. Pigment Black (7).

In the ink of the present disclosure, the pigment has a percentage content of preferably at least 0.5% by mass and no greater than 10.0% by mass, and more preferably at least 1.5% by mass and no greater than 5.0% by mass. As a result of the percentage content of the pigment being set to at least 0.5% by mass, the ink of the present disclosure can form an image with desired image density. As a result of the percentage content of the pigment being set to no greater than 10.0% by mass by contrast, fluidity of the ink of the present disclosure can be ensured.

[Pigment Coating Resin]

The pigment coating resin is a resin soluble in a solvent of the ink of the present disclosure. A portion of the pigment coating resin is present for example on the surfaces of the pigment particles to optimize dispersibility of the pigment particles. Another portion of the pigment coating resin is present in a state of being dissolved in the solvent of the ink of the present disclosure, for example.

The pigment coating resin is preferably acrylic resin. The acrylic resin includes a repeating unit derived from at least one of monomers of (meth)acrylic acid alkyl ester and (meth)acrylic acid.

The pigment coating resin has a percentage content in the ink of the present disclosure of preferably at least 0.1% by mass and no greater than 4.0% by mass, and more preferably at least 0.5% by mass and no greater than 1.5% by mass. As a result of the percentage content of the pigment coating resin being set to at least 0.1% by mass and no greater than 4.0% by mass, ejection stability of the ink of the present disclosure can be ensured.

The content ratio of the pigment coating resin to 100 parts by mass of the pigment in the ink of the present disclosure is preferably at least 10 parts by mass and no greater than 60 parts by mass, and more preferably at least 20 parts by mass and no greater than 30 parts by mass. As a result of the content ratio of the pigment coating resin being set to at least 10 parts by mass and no greater than 60 parts by mass, ejection stability of the ink of the present disclosure can be ensured.

[Polysaccharide]

The polysaccharide is a compound in which monosaccharide molecules are bonded through glycosidic bonding. The polysaccharide may be a natural polysaccharide or a derivative of a natural polysaccharide. Examples of the natural polysaccharide include amylose, amylopectin, starch, dextran, agarose, pectin, xanthan gum, tamarind gum, guar gum, alginic acid, locust bean gum, carrageenan, hyaluronic acid, chitin, heparin, and chondroitin. Examples of the polysaccharide derivative include hydroxypropyl guar gam, cationized guar gum, carboxymethyl cellulose, carboxymethylcellulose salts (e.g., sodium carboxymethylcellulose), hydroxyethyl cellulose, hydroxypropyl cellulose, and cationized cellulose. The polysaccharide is preferably sodium carboxymethylcellulose, xanthan gum, or tamarind gum.

The polysaccharide has a percentage content in the ink of the present disclosure of preferably at least 0.01% by mass and no greater than 0.20% by mass, and more preferably at least 0.03% by mass and no greater than 0.10% by mass. As a result of the percentage content of the polysaccharide being set to at least 0.01% by mass, the ink of the present disclosure can inhibit generation of blots in image formation on a non-permeable recording medium. As a result of the percentage content of the polysaccharide being set to no greater than 0.20% by mass by contrast, the ink of the present disclosure can exhibit excellent ejection stability.

[Water-Soluble Organic Solvent]

The water-soluble organic solvent may function as a solvent or a dispersion medium in the ink of the present disclosure. The water-soluble organic solvent contains a specific glycol ether compound. The water-soluble organic solvent may further contain a specific glycol compound. The total percentage content of the specific glycol ether compound and the specific glycol compound to the total amount of the water-soluble organic solvent in the ink of the present disclosure is preferably at least 90% by mass, and more preferably 100% by mass.

(Specific Glycol Ether Compound)

The specific glycol ether compound includes propylene glycol monomethyl ether, propylene glycol monopropyl ether, dipropylene glycol monomethyl ether, dipropylene glycol monopropyl ether, or triethylene glycol monobutyl ether.

The specific glycol ether compound has a percentage content in the ink of the present disclosure of at least 3.0% by mass and no greater than 24.0% by mass, and preferably at least 10.0% by mass and no greater than 15.0% by mass. As a result of the percentage content of the specific glycol ether compound being set to at least 3.0% by mass, occurrence of repelling of the ink of the present disclosure in image formation on a non-permeable recording medium can be inhibited. As a result of the percentage content of the specific glycol ether compound being set to no greater than 24.0% by mass by contrast, the ink of the present disclosure can exhibit excellent ejection stability.

(Specific Glycol Compound)

The specific glycol compound is a water-soluble organic solvent with a relatively high boiling point and excellent compatibility with the other components contained in the ink of the present disclosure. The specific glycol compound can inhibit nozzle clogging with the ink of the present disclosure, thereby allowing the ink to exhibit ejection stability. The specific glycol compound includes 1,2-propanediol, 3-methyl-1,3-butanediol, 1,2-pentanediol, 2-methyl-1,3-propanediol, 1,3-propanediol, 1,5-pentanediol, or 3-methyl-1,5-pentanediol.

The specific glycol compound has a percentage content in the ink of the present disclosure of preferably at least 3.0% by mass and no greater than 30.0% by mass, more preferably at least 6.0% by mass, and no greater than 25.0% by mass, and further preferably at least 15.0% by mass and no greater than 20.0% by mass. As a result of the percentage content of the specific glycol compounds being set to at least 3.0% by mass and no greater than 30.0% by mass, the ink of the present disclosure can exhibit ejection stability.

A ratio (M_{B}/M_{A}) of a mass M_{B} of the specific glycol compound to a mass M_{A} of the specific glycol ether compound in the ink of the present disclosure is preferably at least 0.25 and no greater than 9.50, and more preferably at least 1.00 and no greater than 3.00. As a result of the ratio (M_{B}/M_{A}) being set to at least 0.25 and no greater than 9.50, the ink of the present disclosure can exhibit ejection stability.

[Water]

The water has a percentage content in the ink of the present disclosure of preferably at least 40.0% by mass and no greater than 80.0% by mass, and more preferably at least 60.0% by mass and no greater than 70.0% by mass.

[Self-Emulsifying Polyolefin Resin Particles]

The self-emulsifying polyolefin resin particles contain hydrophilic polyolefin resin. Examples of the hydrophilic polyolefin resin include polyolefin resin subjected to acid denaturation treatment (e.g., maleic acid treatment) or chlorination treatment, and copolymers of an olefin monomer and a hydrophilic group-containing polymer. The self-emulsifying polyolefin resin particles are dispersible at a concentration of 10% by mass in an aqueous solution with a percentage content of a surfactant of no greater than 1.0% by mass, for example.

The polyolefin resin includes a repeating unit derived from an olefin monomer. Examples of the olefin monomer include ethylene, propylene, 1-butene, 2-butene, isobutene, 1-pentene, 2-pentene, 1-hexene, 2-hexene, 1-heptene, 2-heptene, 1-octene, and 2-octene. The polyolefin resin may further include an additional repeating unit other than the repeating unit derived from an olefin monomer. Examples of monomers other than the olefin monomer include styrene, acrylic acid, and acrylic acid ester.

Examples of the self-emulsifying polyolefin resin particles include self-emulsifying polyethylene resin particles and self-emulsifying polypropylene resin particles. Examples of commercially available self-emulsifying polyolefin resin particles include “SUPERCHLON (registered Japanese trademark) SERIES” produced by Nippon Paper Industries Co., Ltd., “AUROREN (registered Japanese trademark) SERIES” produced by Nippon Paper Industries Co., Ltd., “HARDLEN (registered Japanese trademark) SERIES” produced by Toyobo Co., Ltd., and “APTLOK (registered Japanese trademark) SERIES” produced by Mitsubishi Chemical Corporation.

The self-emulsifying polyolefin resin particles have a volume median diameter (D₅₀) of preferably at least 40 nm and no greater than 400 nm, and more preferably at least 100 nm and no greater than 200 nm. As a result of the volume median diameter of the self-emulsifying polyolefin resin particles being set to at least 40 nm, the ink of the present disclosure can form an image further excellent in adhesion in image formation on a non-permeable recording medium. As a result of the volume median diameter of the self-emulsifying polyolefin resin particles being set to no greater than 400 nm by contrast, the ink of the present disclosure can exhibit ejection stability.

The self-emulsifying polyolefin resin particles have a percentage content in the ink of the present disclosure of preferably at least 0.5% by mass and no greater than 15.0% by mass, and more preferably at least 1.5% by mass and no greater than 5.0% by mass. As a result of the percentage content of the self-emulsifying polyolefin resin particles being set to at least 0.5% by mass, the ink of the present disclosure can form an image further excellent in adhesion in image formation on a non-permeable recording medium. As a result of the percentage content of the self-emulsifying polyolefin resin particles being set to no greater than 15.0% by mass by contrast, the ink of the present disclosure can exhibit excellent ejection stability.

The ratio (M_{Y}/M_{X}) of the mass M_{Y} of the pigment to the mass M_{X} of the self-emulsifying polyolefin resin particles in the ink of the present disclosure is preferably at least 0.24 and no greater than 3.10, and more preferably at least 0.60 and no greater than 1.50. As a result of the ratio (M_{Y}/M_{X}) being set to at least 0.24, the ink of the present disclosure can exhibit excellent ejection stability. As a result of the ratio (M_{Y}/M_{X}) being set to no greater than 3.10 by contrast, the ink of the present disclosure can form an image excellent in adhesion in image formation on a non-permeable recording medium.

[Surfactant]

The surfactant ensures permeability (wettability) of the ink of the present disclosure to a recording medium. Examples of the surfactant include an anionic surfactant, a cationic surfactant, and a nonionic surfactant. The surfactant is preferably a nonionic surfactant.

Examples of the nonionic surfactant include polyoxyethylene dodecyl ether, polyoxyethylene hexyadecyl ether, polyoxyethylene nonylphenyl ether, polyoxyethylene sorbitan monooleate ether, monodecanoyl sucrose, and ethylene oxide adducts of acetylene glycol. The nonionic surfactant is preferably an ethylene oxide adduct of acetylene glycol.

The surfactant has a percentage content in the ink of the present disclosure of preferably at least 0.1% by mass and no greater than 3.0% by mass, and more preferably at least 0.2% by mass and no greater than 1.0% by mass.

[Additional Component]

The ink of the present disclosure may further contain any known additives (e.g., a solution stabilizer, an anti-drying agent, an antioxidant, a viscosity modifier, a pH adjuster, and an antifungal agent) as necessary.

[Ink Production Method]

The ink of the present disclosure can be produced for example by homogenously mixing a pigment dispersion containing the pigment, the polysaccharide, the specific glycol ether compound, a self-emulsifying polyolefin resin particle-containing emulsion, and any additional components (e.g., water, the specific glycol compound, and the surfactant) added as necessary using a stirrer. In production of the ink of the present disclosure, homogenous mixing of each component may be followed by removal of foreign matter and coarse particles using a filter (e.g., a filter with a pore size of no greater than 5 μm).

(Pigment Dispersion)

The pigment dispersion is a dispersion containing the pigment. Preferably, the pigment dispersion further contain the pigment coating resin. Preferably, the dispersion medium of the pigment dispersion is water.

The pigment has a percentage content in the pigment dispersion of preferably at least 5.0% by mass and no greater than 25.0% by mass, and more preferably at least 10.0% by mass and no greater than 20.0% by mass. The pigment coating resin has a percentage content in the pigment dispersion of preferably at least 1.0% by mass and no greater than 10.0% by mass, and more preferably at least 2.0% by mass and no greater than 6.0% by mass.

The pigment dispersion can be prepared by wet dispersion of the pigment, the pigment coating resin, a dispersion medium (e.g., water), and a component (e.g., a surfactant) added as necessary using a media type wet disperser. In wet dispersion using a media type wet disperser, small-diameter beads (e.g., beads with a D₅₀ of at least 0.5 mm and no greater than 1.0 mm) can be used as a medium. No particular limitations are placed on the material of the beads, and the material of the beads is preferably a hard material (e.g., glass or zirconia).

In a case in which a pigment dispersion is added in production of the ink of the present disclosure, the percentage content of the pigment dispersion to all the raw materials of the ink is preferably at least 10.0% by mass and no greater than 40.0% by mass, for example.

(Self-Emulsifying Polyolefin Resin Particle-Containing Emulsion)

The self-emulsifying polyolefin resin particle-containing emulsion is a dispersion containing the self-emulsifying polyolefin resin particles. Water is preferable as a dispersion medium of the self-emulsifying polyolefin resin particle-containing emulsion.

The self-emulsifying polyolefin resin particles has a percentage content in the self-emulsifying polyolefin resin particle-containing emulsion of preferably at least 10.0% by mass and no greater than 40.0% by mass, and more preferably at least 20.0% by mass and no greater than 35.0% by mass.

In a case in which the self-emulsifying polyolefin resin particle-containing emulsion is added in production of the ink of the present disclosure, the ratio of the self-emulsifying polyolefin resin particle-containing emulsion to all the raw materials of the ink is at least 3.0% by mass and no greater than 45.0% by mass, for example.

### EXAMPLES

The following describes examples of the present disclosure. However, the present disclosure is not limited to the following examples.

[Preparation of Cyan Pigment Dispersion]

Using a disperser mixer, 15 parts by mass of a cyan pigment (“HELIOGEND BLUE 7088”, product of BASF, C.I. Pigment Blue 15:3) as the pigment, 10 parts by mass of a pigment coating resin-containing liquid (“DISPERBYK (registered Japanese trademark) 190”, product of BYK JAPAN KK, acrylic resin-containing dispersion, nonvolatile content: 40%), and 75 parts by mass of water were pre-mixed. The resultant mixture was subjected to dispersion treatment for 4 hours using a bead mill (“DYNO MILL”, product of Willy A. Bachofen AG, capacity 0.6 L). In the dispersion treatment, 1800 g of zirconia beads (diameter 0.1 mm) were used as a medium. Through the above, a cyan pigment dispersion was prepared.

[Preparation of Black Pigment Dispersion]

A black pigment dispersion was prepared according to the same method as that for preparing the cyan pigment dispersion in all aspects other than change of the pigment from the cyan pigment to 15 parts by mass of a black pigment (“PRINTEX (registered Japanese trademark) 85”, product of Orion Engineered Carbons KK).

[Resin Particle-Containing Emulsion]

The following resin particle-containing emulsions (E-1) to (E-3) were prepared as raw materials for ink production.

Resin particle-containing emulsion (E-1): emulsion (“APTLOK (registered Japanese trademark) BW-5635, product of Mitsubishi Chemical Corporation, nonvolatile content: 30% by mass, D₅₀: 140 nm) containing self-emulsifying polyolefin resin particles (A)

Resin particle-containing emulsion (E-2): emulsion (ZAIKTHENE (registered Japanese trademark) A”, product of Sumitomo Seika Chemicals Company, Limited, nonvolatile content: 25% by mass, D₅₀: 180 nm) containing self-emulsifying polyolefin resin particles (B)

Resin particle-containing emulsion (E-3): emulsion (“SUPERFLEX 820”, product of DKS Co. Ltd., nonvolatile content: 30% by mass, D₅₀: 30 nm) containing urethane resin particles

[Polysaccharide]

The following polysaccharides were prepared as raw materials for ink production.

Carboxymethyl cellulose: “CMC DAICEL (registered Japanese trademark) 1330”, product of Daicel Miraizu Ltd.

Xanthan gum: “ECHO GUM (registered Japanese trademark)”, product of Sumitomo Pharma Food & Chemical Co., Ltd.

Tamarind gum: “GLYLOID (registered Japanese trademark) 6C”, product of Sumitomo Pharma Food & Chemical Co., Ltd.

<Ink Preparation>

Inks of Examples 1 to 13 and Comparative Examples 1 to 8 were prepared according to the following methods.

### Example 1

Using a stirrer (“THREE-ONE MOTOR BL-600”, product of Shinto Scientific Co., Ltd.), 20.0 parts by mass of the cyan pigment dispersion (cyan pigment: 3.0 parts by mass), 0.05 parts by mass of carboxymethyl cellulose, 12.0 parts by mass of propylene glycol monomethyl ether, 18.0 parts by mass of 1,2-propanediol, 10.0 parts by mass of the resin particle-containing emulsion (E-1) (polyolefin resin particles (A): 3.0 parts by mass), and 0.4 parts by mass of a surfactant (“OLFINE (registered Japanese trademark) E1010”, product of Nissin Chemical Industry Co., Ltd., ethylene oxide adduct of acetylenediol) were stirred and mixed uniformly at a rotational speed of 400 rpm. The resultant mixed liquid was filtered using a filter with a pore size of 5 μm in order to remove foreign matter and coarse particles from the mixed liquid. Through the above, an ink of Example 1 was prepared.

### Examples 2 to 13 and Comparative Examples 1 to 8

Inks of Examples 2 to 13 and Comparative Examples 1 to 8 were prepared according to the same method as that for preparing the ink of Example 1 in all aspects other than changes in types and amounts of the raw materials so that components of the respective inks were as shown below in Tables 1 to 3. Note that “part” below in Tables 1 to 3 indicates part by mass.

TABLE 1

| | | Example | | | | | | |
|---|---|---|---|---|---|---|---|---|
| | | 1 | 2 | 3 | 4 | 5 | 6 | 7 |
| Pigment [part] | Cyan pigment | 3.0 | 3.0 | 3.0 | 3.0 | 3.0 | 3.0 | 3.0 |
| | Black pigment | — | — | — | — | — | — | — |
| Polysaccharide | Sodium carboxymethylcellulose | 0.05 | 0.05 | 0.01 | 0.20 | 0.05 | 0.05 | 0.05 |
| [part] | Xanthan gum | — | — | — | — | — | — | — |
| | Tamarind gum | — | — | — | — | — | — | — |
| Glycol ether | Propylene glycol monomethyl ether | 12.0 | — | — | — | — | 24.0 | — |
| compound [part] | Propylene glycol monopropyl ether | — | — | 12.0 | — | — | — | — |
| | Dipropylene glycol monomethyl ether | — | — | — | 12.0 | — | — | 6.0 |
| | Dipropylene glycol monopropyl ether | — | — | — | — | — | — | — |
| | Triethylene glycol monobutyl ether | — | 12.0 | — | — | 3.0 | — | 6.0 |
| | Triethylene glycol monomethyl ether | — | — | — | — | — | — | — |
| Glycol | 1,2-Propanediol | 18.0 | — | — | — | — | — | — |
| compound [part] | 3-Methyl-1,3-butanediol | — | — | 18.0 | — | — | — | — |
| | 1,2-Pentanediol | — | — | — | 18.0 | — | — | — |
| | 2-Methyl-1,3-propanediol | — | — | — | — | 27.0 | — | — |
| | 1,3-Propanediol | — | 18.0 | — | — | — | — | — |
| | 1,5-Pentanediol | — | — | — | — | — | 6.0 | — |
| | 3-Methyl-1,5-pentanediol | — | — | — | — | — | — | 18.0 |
| Resin particles | Polyolefin resin particles (A) | 3.0 | 3.0 | 3.0 | 3.0 | 3.0 | 3.0 | 3.0 |
| [part] | Polyolefin resin particles (B) | — | — | — | — | — | — | — |
| | Urethane resin particles | — | — | — | — | — | — | — |

| | | | | | | | |
|---|---|---|---|---|---|---|---|
| Surfactant [part] | 0.4 | 0.4 | 0.4 | 0.4 | 0.4 | 0.4 | 0.4 |
| Water [part] | Rest | Rest | Rest | Rest | Rest | Rest | Rest |
| Total [part] | 100 | 100 | 100 | 100 | 100 | 100 | 100 |
| Pigment/resin particles | 1.0 | 1.0 | 1.0 | 1.0 | 1.0 | 1.0 | 1.0 |
| Glycol compound/glycol ether compound | 1.5 | 1.5 | 1.5 | 1.5 | 9.0 | 0.25 | 1.5 |

TABLE 2

| | | | | | | | | Comparative |
|---|---|---|---|---|---|---|---|---|
| | | Example | | | | | | Example |
| | | 8 | 9 | 10 | 11 | 12 | 13 | 1 |
| Pigment [part] | Cyan pigment | 3.0 | 3.0 | — | 3.0 | 3.0 | 3.0 | 3.0 |
| | Black pigment | — | — | 3.0 | — | — | — | — |
| Polysaccharide | Sodium carboxymethylcellulose | 0.05 | 0.05 | 0.05 | — | — | 0.05 | 0.005 |
| [part] | Xanthan gum | — | — | — | 0.05 | — | — | — |
| | Tamarind gum | — | — | — | — | 0.20 | — | — |
| Glycol ether | Propylene glycol monomethyl ether | — | — | 12.0 | — | — | 12.0 | 12.0 |
| compound [part] | Propylene glycol monopropyl ether | — | — | — | — | — | — | — |
| | Dipropylene glycol monomethyl ether | — | — | — | — | 12.0 | — | — |
| | Dipropylene glycol monopropyl ether | 12.0 | 12.0 | — | — | — | — | — |
| | Triethylene glycol monobutyl ether | — | — | — | 12.0 | — | — | — |
| | Triethylene glycol monomethyl ether | — | — | — | — | — | — | — |
| Glycol | 1,2-Ppropanediol | — | — | 18.0 | — | — | 18.0 | 18.0 |
| compound [part] | 3-Methyl-1,3-butanediol | — | — | — | — | — | — | — |
| | 1,2-Pentanediol | — | — | — | — | 18.0 | — | — |
| | 2-Methyl-1,3-propanediol | — | — | — | — | — | — | — |
| | 1,3-Propanediol | — | 18.0 | — | 18.0 | — | — | — |
| | 1,5-Pentanediol | 18.0 | — | — | — | — | — | — |
| | 3-Methyl-1,5-pentanediol | — | — | — | — | — | — | — |
| Resin particles | Polyolefin resin particles (A) | 12.0 | 1.0 | 3.0 | 3.0 | 3.0 | — | 3.0 |
| [part] | Polyolefin resin particles (B) | — | — | — | — | — | 4.2 | — |
| | Urethane resin particles | — | — | — | — | — | — | — |

| | | | | | | | |
|---|---|---|---|---|---|---|---|
| Surfactant [part] | 0.4 | 0.4 | 0.4 | 0.4 | 0.4 | 0.4 | 0.4 |
| Water [part] | Rest | Rest | Rest | Rest | Rest | Rest | Rest |
| Total [part] | 100 | 100 | 100 | 100 | 100 | 100 | 100 |
| Pigment/resin particles | 0.25 | 3.0 | 1.0 | 1.0 | 1.0 | 0.7 | 1.0 |
| Glycol compound/glycol ether compound | 1.50 | 1.50 | 1.50 | 1.50 | 1.50 | 1.50 | 1.50 |

TABLE 3

| | | Comparative Example | | | | | | |
|---|---|---|---|---|---|---|---|---|
| | | 2 | 3 | 4 | 5 | 6 | 7 | 8 |
| Pigment [part] | Cyan pigment | 3.0 | 3.0 | 3.0 | 3.0 | 3.0 | 3.0 | 3.0 |
| | Black pigment | — | — | — | — | — | — | — |
| Polysaccharide | Sodium carboxymethylcellulose | 0.22 | 0.05 | 0.05 | 0.05 | 0.05 | 0.05 | 0.05 |
| [part] | Xanthan gum | — | — | — | — | — | — | — |
| | Tamarind gum | — | — | — | — | — | — | — |
| Glycol ether | Propylene glycol monomethyl ether | — | — | — | 12.0 | 12.0 | 12.0 | — |
| compound [part] | Propylene glycol monopropyl ether | — | — | — | — | — | — | — |
| | Dipropylene glycol monomethyl ether | 12.0 | — | — | — | — | — | — |
| | Dipropylene glycol monopropyl ether | — | 2.5 | — | — | — | — | — |
| | Triethylene glycol monobutyl ether | — | — | 25.0 | — | — | — | — |
| | Triethylene glycol monomethyl ether | — | — | — | — | — | — | 12.0 |
| Glycol | 1,2-Propanediol | — | — | — | 18.0 | 18.0 | 18.0 | — |
| compound [part] | 3-Methyl-1,3-butanediol | — | — | — | — | — | — | — |
| | 1,2-Pentanediol | 18.0 | 27.0 | — | — | — | — | — |
| | 2-Methyl-1,3-propanediol | — | — | 5.0 | — | — | — | — |
| | 1,3-Propanediol | — | — | — | — | — | — | — |
| | 1,5-Pentanediol | — | — | — | — | — | — | — |
| | 3-Methyl-1,5-pentanediol | — | — | — | — | — | — | 18.0 |
| Resin particles | Polyolefin resin particles (A) | 3.0 | 3.0 | 3.0 | 0.94 | 13.0 | — | 3.0 |
| [part] | Polyolefin resin particles (B) | — | — | — | — | — | — | — |
| | Urethane resin particles | — | — | — | — | — | 3.0 | — |

| | | | | | | | |
|---|---|---|---|---|---|---|---|
| Surfactant [part] | 0.4 | 1.4 | 0.4 | 0.4 | 0.4 | 0.4 | 0.4 |
| Water [part] | Rest | Rest | Rest | Rest | Rest | Rest | Rest |
| Total [part] | 100 | 100 | 100 | 100 | 100 | 100 | 100 |
| Pigment/resin particles | 1.0 | 1.0 | 1.0 | 3.2 | 0.23 | 1.0 | 1.0 |
| Glycol compound/glycol ether compound | 1.50 | 10.80 | 0.20 | 1.50 | 1.50 | 1.50 | 1.50 |

<Evaluation>

Ejection stability, occurrence or non-occurrence of blotting and ink repelling in image formation on a non-permeable recording medium, and adhesion of formed images were evaluated for each of the inks (evaluation targets) of Examples 1 to 13 and Comparative Examples 1 to 8 by the following methods. Evaluation results are shown below in Tables 4 and 5. Note that each evaluation was carried out at a temperature of 25° C. and a relative humidity of 60%.

[Evaluation Apparatus]

An inkjet recording apparatus (prototype produced by KYOCERA Document Solutions Japan Inc.) equipped with a line head was used as an evaluation apparatus.

[Blotting]

Using the evaluation apparatus, a fine line with a 1-dot line width was formed on each of a sheet of an OPP film (“TORAYFAN (registered Japanese trademark) #50-2500H”, product of Toray Industries, Inc.) being a non-permeable recording medium and a sheet of mat paper (“SUPER FINE PAPER”, product of Seiko Epson Corporation). Next, a line width A [mm] of the fine line formed on the OPP film sheet and a line width B [mm] of the fine line formed on the mat paper sheet were measured. Thereafter, a value obtained by calculation by applying the line width A and the line width B to the following equation was taken to be an evaluation value of blotting in image formation on the non-permeable recording medium. Blotting was evaluated according to the following criteria.

Evaluation value of blotting=(line width A)/(line width B)

(Criteria for Blotting)

A (Good): evaluation value of no greater than 1.00

B (Poor): evaluation value of greater than 1.00

[Ink Repelling]

Using the evaluation apparatus, a solid image was formed on a sheet of the OPP film. Each end of the formed solid image was visually observed to determine occurrence or non-occurrence of image defects resulting from ink repelling. Ink repelling was evaluated according to the following criteria.

(Criteria for Ink Repelling)

A (Good): ink repelling was not observed.

B (Poor): ink repelling was observed.

[Adhesion]

Using the evaluation apparatus, a solid image was formed on a sheet of the OPP film. A grid test (cross-cut test) in accordance with K5600-5-6:1999 prescribed in the Japanese Industrial Standards (JIS) was carried out on the OPP film sheet. Specifically, lattice-like (grid-like) incisions of 6 lengthwise incisions and 6 widthwise incisions at 2-mm intervals were formed in the solid image formed on the OPP film sheet to form 25 square cells of 2 mm on each side. Adhesive tape (“CELLOTAPE (registered Japanese trademark) CT-24”, product of Nichiban Co., Ltd.) was attached onto the solid image with the incisions, and peeled off at once at an angle of approximately 45 degrees. After the peeling off of the adhesive tape, the 25 cells of the solid image were observed and the number of cells with solid image peeling or chipping resulting from the peeling off was counted. Adhesion was evaluated according to the following criteria.

(Criteria for Adhesion)

A (Good): the number of cells with peeling or chipping of at least 0 and no greater than 5

B (Poor): the number of cells with peeling or chipping of at least 6 and no greater than 25

[Ejection Stability]

Using the evaluation apparatus, a solid image was consecutively formed on 100 sheets of the mat paper. Next, purging for ink purging was carried out on the recording head of the evaluation apparatus. Then, wiping using a cleaning wiper was carried out for wiping the ink ejection surface of the recording head. Next, a nozzle check pattern was formed on a sheet of the mat paper using the evaluation apparatus. This resulted in confirmation that the ink has been ejected from all the nozzles in each of the evaluation targets. Next, the aforementioned purging and wiping were carried out on the recording head of the evaluation apparatus. Next, the evaluation apparatus was left to stand for 8 hours with the recording head thereof uncapped. Next, the aforementioned purging and wiping were carried out on the recording head of the evaluation apparatus. Next, the nozzle check pattern was formed on a sheet of the mat paper using the evaluation apparatus. Thereafter, the formed nozzle check pattern was observed to count the number of nozzles with nozzle clogging. A ratio of the number of the nozzles with nozzle clogging to the number of all the nozzles of the recording head of the evaluation apparatus was taken to be an evaluation value of ejection stability. Ejection stability was evaluated according to the following criteria.

(Criteria for Ejection Stability)

A (Good): evaluation value of less than 10%

B (Poor): evaluation value of at least 10%

TABLE 4

| | | Example | | | | | | | | | |
|---|---|---|---|---|---|---|---|---|---|---|---|
| | | 1 | 2 | 3 | 4 | 5 | 6 | 7 | 8 | 9 | 10 |
| Blotting | Line width | 0.88 | 0.91 | 0.85 | 0.89 | 0.77 | 0.93 | 0.79 | 0.80 | 0.92 | 0.78 |
| | Evaluation | A | A | A | A | A | A | A | A | A | A |

| | | | | | | | | | | |
|---|---|---|---|---|---|---|---|---|---|---|
| Ink repelling | A | A | A | A | A | A | A | A | A | A |
| Adhesion | A | A | A | A | A | A | A | A | A | A |
| Ejection stability | A | A | A | A | A | A | A | A | A | A |

TABLE 5

| | | Example | | | Comparative Example | | | | | | | |
|---|---|---|---|---|---|---|---|---|---|---|---|---|
| | | 11 | 12 | 13 | 1 | 2 | 3 | 4 | 5 | 6 | 7 | 8 |
| Blotting | Line width | 0.80 | 0.86 | 0.82 | 1.11 | 0.91 | 0.65 | 1.15 | 0.80 | 0.95 | 0.88 | 0.54 |
| | Evaluation | A | A | A | B | A | A | B | A | A | A | B |

| | | | | | | | | | | | |
|---|---|---|---|---|---|---|---|---|---|---|---|
| Ink repelling | A | A | A | A | A | B | A | A | A | A | B |
| Adhesion | A | A | A | A | A | B | A | B | A | B | A |
| Ejection stability | A | A | A | A | B | A | B | A | B | A | A |

As shown in Tables 1 to 3, each of the ink of Examples 1 to 13 contained a pigment, a polysaccharide, a water-soluble organic solvent, and self-emulsifying polyolefin resin particles. The polysaccharide had a percentage content of at least 0.01% by mass and no greater than 0.2% by mass. The water-soluble organic solvent contained a specific glycol ether compound. The specific glycol ether compound included propylene glycol monomethyl ether, propylene glycol monopropyl ether, dipropylene glycol monomethyl ether, dipropylene glycol monopropyl ether, or triethylene glycol monobutyl ether. The specific glycol ether compound had a percentage content of at least 3.0% by mass and no greater than 24.0% by mass. The ratio (M_{Y}/M_{X}) of the mass M_{Y} of the pigment to the mass M_{X} of the self-emulsifying polyolefin resin particles was at least 0.24 and no greater than 3.10. As shown in Tables 4 and 5, the inks of Examples 1 to 13 each were excellent in ejection stability and each formed an image excellent in adhesion while inhibiting generation of blots and occurrence of ink repelling in the image formation on the non-permeable recording medium.

By contrast, the ink of Comparative Example 1 had a content percentage of the polysaccharide of less than 0.01% by mass. Blotting occurred in the image formation on the non-permeable recording medium using the ink of Comparative Example 1 due to the insufficient amount of the polysaccharide therein.

The ink of Comparative Example 2 had a content percentage of the polysaccharide of greater than 0.20% by mass. The ink of Comparative Example 2 was poor in ejection stability due to the excessive amount of the polysaccharide therein.

The ink of Comparative Example 3 had a content percentage of the specific glycol ether compound of less than 3.0% by mass. Blots were generated in the image formation on the non-permeable recording medium using the ink of Comparative Example 3 due to the insufficient amount of the specific glycol ether compound therein. In addition, the image formed in the image formation on the non-permeable recording medium using the ink of Comparative Example 3 was poor in adhesion.

The ink of Comparative Example 4 had a content percentage of the specific glycol ether compound of greater than 24.0% by mass. The ink of Comparative Example 4 was poor in ejection stability due to the excessive amount of the specific glycol ether compound therein.

The ratio (M_{Y}/M_{X}) of the mass M_{Y} of the pigment to the mass M_{X} of the self-emulsifying polyolefin resin particles in the ink of Comparative Example 5 was greater than 3.10. The image formed in the image formation on the non-permeable recording medium using the ink of Comparative Example 5 was poor in adhesion due to the insufficient mass of the self-emulsifying polyolefin resin particles relative to the mass of the pigment.

The ratio (M_{Y}/M_{X}) of the mass M_{Y} of the pigment to the mass M_{X} of the self-emulsifying polyolefin resin particles in the ink of Comparative Example 6 was less than 0.24. The ink of Comparative Example 6 was poor in ejection stability due to the excessive mass of the self-emulsifying polyolefin resin particles relative to the mass of the pigment.

The ink of Comparative Example 7 contained urethane resin particles instead of self-emulsifying polyolefin resin particles. The urethane resin particles were inferior to the self-emulsifying polyolefin resin particles in compatibility with the non-permeable recording medium. As a result, the image formed in the image formation on the non-permeable recording medium using the ink of Comparative Example 7 was poor in adhesion.

The ink of Comparative Example 8 contained a glycol ether compound other than the specific glycol ether compound. The glycol ether compound other than the specific glycol ether compound insufficiently ensures wettability of an ink to a non-permeable recording medium. As a result, ink repelling occurred in the image formation on the non-permeable recording medium using the ink of Comparative Example 8.

What is claimed is:

1. An inkjet ink comprising:
a pigment;
a polysaccharide;
a water-soluble organic solvent; and
self-emulsifying polyolefin resin particles, wherein
the polysaccharide has a percentage content of at least 0.01% by mass and no greater than 0.20% by mass,
the water-soluble organic solvent contains a specific glycol ether compound,
the specific glycol ether compound includes propylene glycol monomethyl ether, propylene glycol monopropyl either, dipropylene glycol monomethyl ether, dipropylene glycol monopropyl ether, or triethylene glycol monobutyl ether,
the specific glycol ether compound has a percentage content of at least 3.0% by mass and no greater than 24.0% by mass, and
a ratio (M_{Y}/M_{X}) of a mass M_{Y} of the pigment to a mass M_{X} of the self-emulsifying polyolefin resin particles is at least 0.24 and no greater than 3.10.

2. The inkjet ink according to claim 1, wherein
the polysaccharide includes sodium carboxymethylcellulose, xanthan gum, or tamarind gum.

3. The inkjet ink according to claim 1, wherein
the water-soluble organic solvent further contains a specific glycol compound, and
the specific glycol compound includes 1,2-propanediol, 3-methyl-1,3-butanediol, 1,2-pentanediol, 2-methyl-1,3-propanediol, 1,3-propanediol, 1,5-pentanediol, or 3-methyl-1,5-pentanediol.

4. The inkjet ink according to claim 3, wherein
a ratio (M_{B}/M_{A}) of a mass M_{B} of the specific glycol compound to a mass M_{A} of the specific glycol ether compound is at least 0.25 and no greater than 9.50.

5. The inkjet ink according to claim 1, wherein
the self-emulsifying polyolefin resin particles have a percentage content of at least 1.0% by mass and no greater than 10.0% by mass.
